(19) United States
(12) Patent Application Publication
(10) Pub. No.: US 2013/0185994 A1
(43) Pub. Date: Jul. 25, 2013

(54) PLANT SUPPORT STAKE

(71) Applicant: Ernest Donald Torok, Elk Point (CA)

(72) Inventor: Ernest Donald Torok, Elk Point (CA)

(21) Appl. No.: 13/355,438

(22) Filed: Jan. 20, 2012

(51) Int. Cl. A01G 17/14

(52) U.S. Cl. 47/47

(57) ABSTRACT

An apparatus for supporting a plant having a stem comprises a base, an upright member extending substantially vertically upward from the base proximate to the plant and at least three ground penetrating members extending from the base. The ground penetrating members are substantially parallel to the upright and spaced at least 4 inches therefrom.

### BACKGROUND OF THE INVENTION

1. Field of Invention

The present disclosure relates to plants in general and in particular to a method and apparatus for supporting a plant having reduced impact on the roots of the plant.

2. Description of Related Art

Plants are frequently in need of additional support from weather or protection from being damaged by contact with people or animals. In particular, rain, snow the leaves or fruit of the plant may be prone to bending the stalk of a plant due to the weight the stalk is required to support. This is particularly the case for relatively young plants or plants which have been recently transplanted.

Conventionally, to prevent plants from becoming damaged, it has been common to provide a stake or pole proximate to the plant to which the plant is tied. Such stakes, however are required to be inserted into the ground in close proximity to the stalk or trunk of the plant so as to provide the required level of support. Locating a stake at such a location is known to have several difficulties. Firstly, many conventional stakes which are utilized are made of wood which is known to rot or decay after a prolonged period of time in the ground. Therefore, any such stakes must therefore be periodically replaced if continued use is required. Secondly, locating stakes into the ground proximate to the plant is likely to encounter and therefore damage the roots of the plant. Such stakes are also of limited support due to the single point of contact within the ground.

Previous attempts to solve the above difficulties have not been adequate. Applicant is aware of attempts to provide additional support to a conventional tree stake by providing one or more additional spaced apart stakes. Examples of such devices may be found in U.S. Pat. No. 5,473,839 to Stidham, U.S. Pat. No. 3,136,510 to Bowersw et al., and U.S. Pat. No. 1,893,335 to Muller. Such devices however still retain a center stake proximate to the plant and would therefore be prone to damaging the plant roots.

Applicant is also aware of previous attempts to provide plant supports having a plurality of spaced apart legs extending from a plant supporting stem. Examples of such devices may be found in U.S. Pat. No. 1,536,679 to Markowski and U.S. Pat. No. 1,536,678 to Markowski. Such devices, however, are formed of several parts which are pivotally connected to each other which reduces the strength of the overall device and is also more difficult and time consuming both to manufacture as well as for a user to operate.

### SUMMARY OF THE INVENTION

According to a first embodiment of the present invention there is disclosed an apparatus for supporting a plant having a stem, the apparatus comprising a first support member extending between first and second ends having an upright portion proximate to the first end, a first ground penetrating member proximate to the second end and a vertical offset portion therebetween. The apparatus further comprises a second support member having second and third spaced apart ground penetrating members and a connecting portion therebetween. The connecting portion of the second support member is connected to the first member

The second support member may be secured to the offset portion of the first support member by a method selected from the group comprising welding, brazing, adhesives, utilizing fasteners or soldering. The first and second support members may be co-formed with each other.

The first second and third ground penetrating members may be substantially parallel with each other. The first second and third ground penetrating members may be substantially aligned with the upright portion. The first second and third ground penetrating members may be offset from the upright portion by an offset distance. The offset distance may be selected to be between 2.5 and 24 inches.

According to a further embodiment of the present invention there is disclosed an apparatus for supporting a plant having a stem. The apparatus comprises a base, an upright member extending substantially vertically upward from the base proximate to the plant and at least three ground penetrating members extending from the base. The ground penetrating members are substantially parallel to the upright and spaced at least 4 inches therefrom.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an apparatus according to a first embodiment of the present invention applied to a plant.

FIG. 2 is a perspective view of the apparatus of FIG. 1.

FIG. 3 is a perspective view of an apparatus according to a further embodiment of the present invention.

FIG. 4 is a bottom plan view of an apparatus according to a further embodiment of the present invention.

### DETAILED DESCRIPTION

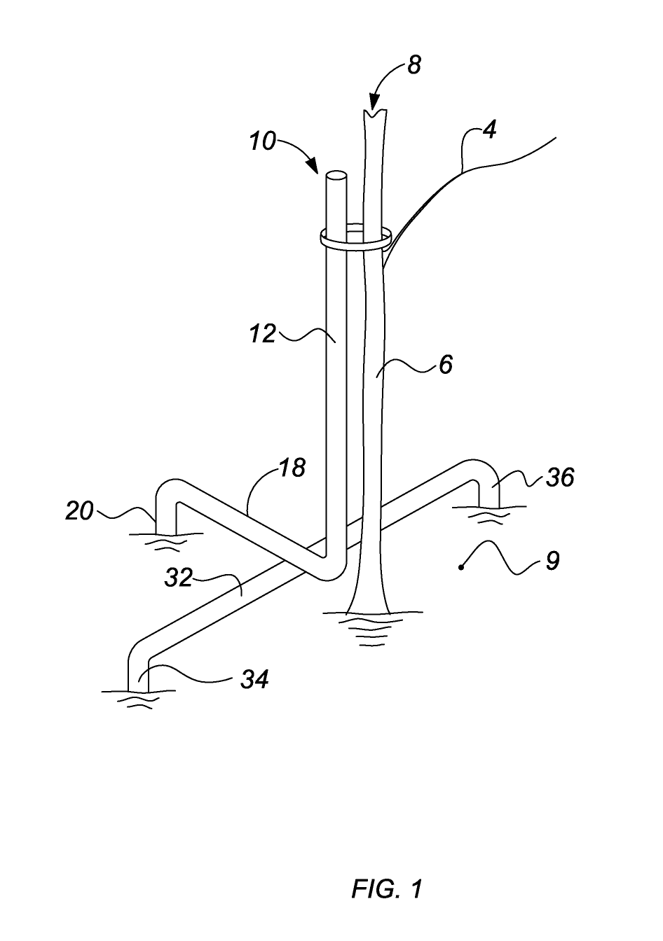

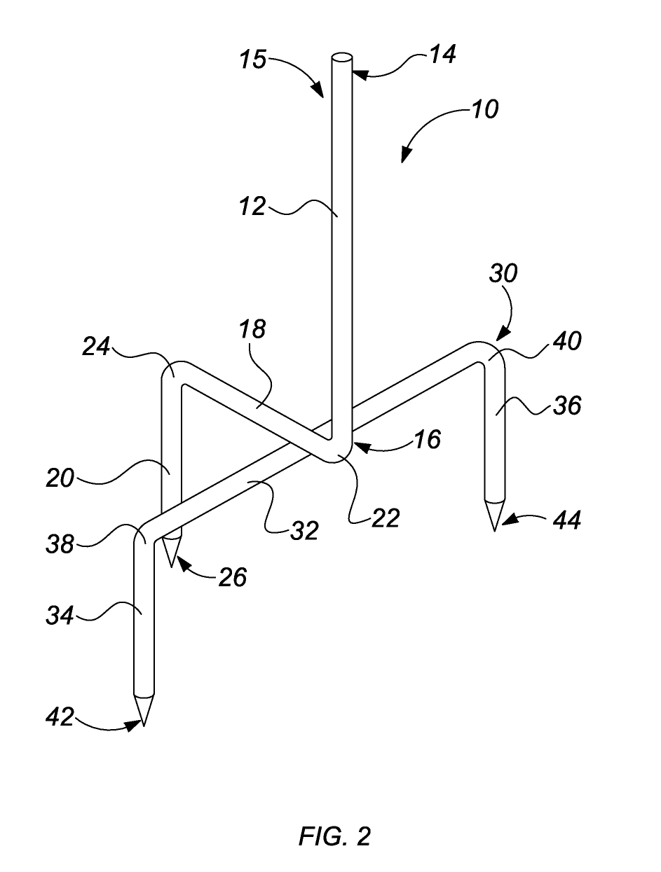

Referring to FIGS. 1 and 2, an apparatus for supporting a plant according to a first embodiment of the present invention is shown generally at 10 engaged with the ground 9 proximate to and applied to a plant 8. The plant may include a stem 8 and one or more branch 4. The apparatus comprises an upright member 12 and a first ground penetrating member 20 formed of a unitary member with an offset portion 18 therebetween. The apparatus also comprises a second support member, 30 comprising a horizontal member or connecting portion 32 having a pair of parallel spaced apart ground penetrating members 34 and 36, at opposed ends thereof. As illustrated each of the ground penetrating members is space radially away from the upright member 12 and therefore from the plant as well so as to reduce the chances of one of the ground penetrating members damaging the roots of the plant.

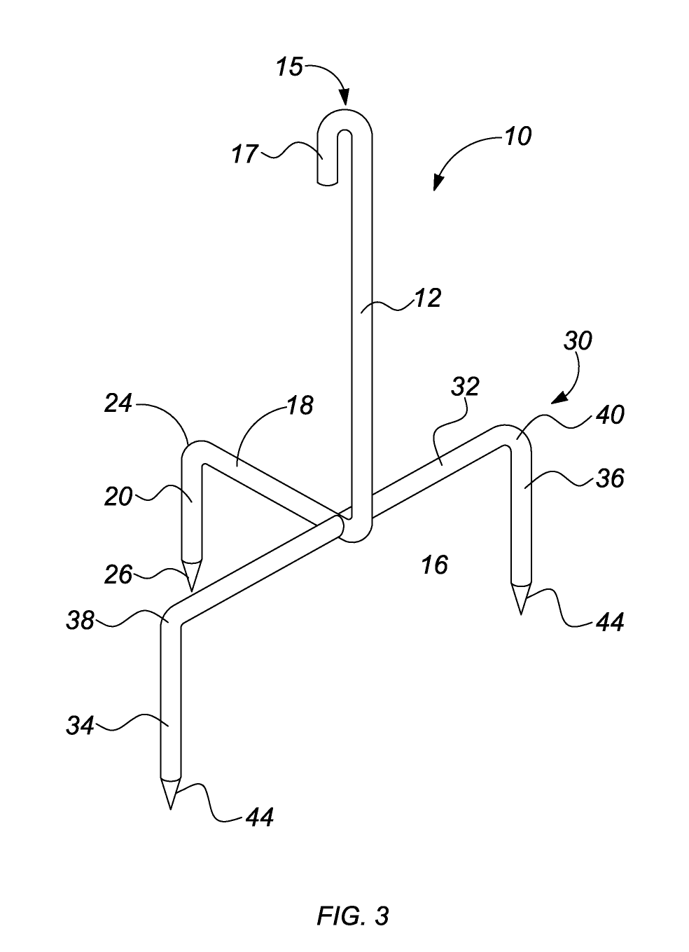

The upright member 12 extends between first or top 14 and second or bottom 16 ends and may be formed of an elongate rigid member. The upright 12 is connected to a first end the offset portion 18 at the bottom end 16 thereof. The opposed end of the offset portion 18 is connected to the first ground penetrating member 20 which extends therefrom in an opposite direction as the upright 12. As illustrated, upright member 12, offset portion 18 and first ground engaging member may be formed of a continuous unitary member having first and second bends, 22 and 24, respectively therein so as to form a first support member 15 having a z-shape. The first and second bends may have any angle as desired by a user, although it will be appreciated that 90 degree angles will be particularly useful so as to permit the upright 12 and first ground penetrating member to be substantially parallel to each other and wherein the connecting portion 18 will be substantially parallel to the ground 9 when inserted proximate to a plant 8. As illustrated in FIG. 3, the top end 14 of the upright member may optionally include a bent or doubled over portion, 17 so as to present a smoother top end of the apparatus which will be less prone to injuring a person falling on the apparatus. It will be appreciated that other methods may also be used, such as to provide a bulbed or rounded top end.

The second support member 30 is fixedly secured to the first support member 15, such as connected to the bottom of the offset portion 18 proximate to the first bend 22 as illustrated, such as, by way of non-limiting example below the upright member 12. It will be appreciated that the second support member 30 may also be secured to the first support member at other locations as well, such as to the upright 12 or at any other location along the connecting portion 18. As illustrated, the connecting portion 32 and second and third ground penetrating members 34 and 36 may be formed of a continuous unitary member having first and second bends, 38 and 40, respectively separating each region thereof. Each of the first, second and third ground engaging members 20, 34 and 36 may optionally include a sharpened end, 26, 42 and 44 as illustrated to facilitate insertion into the ground 9.

The second support member 30 may be secured to the first support member in any conventionally known means, such as, by way of non-limiting example, welding, brazing, adhesives, utilizing fasteners, soldering or the like. The first and second support members may be formed of two separate members and thereafter fixedly connected together as set out above. Optionally, the first and second support members may be co-formed as a single unit, such as, by way of non-limiting example, through moulding, casting or the like as illustrated in FIG. 3 such as, by way of non-limiting example, when formed of moulded plastic.

The first and second support members may be formed of any suitable rigid material and in any cross section shape. As illustrated, the first and second support members 15 and 30 may be formed of a wire or round bar, although it will be appreciated that other cross-sectional shapes may be useful as well, such as, by way of non-limiting example, square T-shaped, I-beam shaped, or any other shape as desired by a user. The first and second support members 15 and 30 may be formed of any suitable material, such as, by way of non-limiting example, steel, stainless steel, aluminium or plastic. The size and shape of the first and second support members 15 and 30 may also be selected to provide the desired level of strength and support to the plant in accordance with known principles, such as, by way of non-limiting example, from round material having diameters between 1/16 and 1½ inches (2 and 38 mm).

The upright 12 may have a height selected to correspond to the height of the plant that is desired to be supported. In practice, it has been found that a height of between 24 and 60 inches (610 and 1524 mm) has been found to be useful with a height of approximately 48 inches (1219 mm) being particularly useful. The ground penetrating members 20, 34 and 36 may have a length sufficient to permit them to be embedded in the ground by a sufficient amount to provide the desired degree of support to the plant. In practice, it has been fund that a length of between 3 and 12 inches (76 and 305 mm) has been useful with a length of approximately 6 inches (152 mm) being particularly useful. The lengths of the offset portion 18 and the connection portion 32 may also be selected to space the first second and third ground penetrating members 20, 34 and 36 apart from upright and therefore from any plant to which it is applied by a distance sufficient to reduce damaging the roots of the plant. In practice, it has been found that providing lengths sufficient to space the ground penetrating members by a distance of between 2.5 and 24 inches (64 and 610 mm) away from the upright has been useful with a distance of approximately 6 inches (152 mm) being particularly useful.

In operation, a user may locate the upright 12 proximate and parallel to the stem 6 of the plant and thereafter press the apparatus in a downward motion so as to insert the ground penetrating members 20, 34 and 36 into the ground radially spaced around the plant. Thereafter, the upright may optionally be secured to the stem 6 by any known means, such as, by way of non-limiting example, straps 25 ribbons, strings or the like.

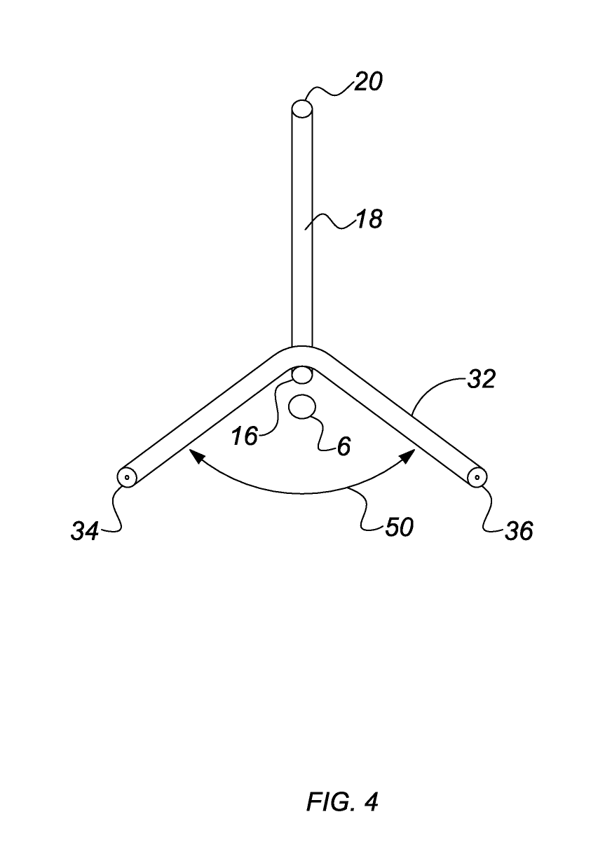

With reference to FIG. 4, an optional embodiment of the present invention is illustrated having a second support member 32 with a bend angle therein so as to more evenly space the ground penetrating members 20, 34 and 36 around the upright 12 and therefore also radially around the plant 8. As illustrated, the second support member 32 may have an angle therein, generally indicated at 50. The bend angle may have a range of between 50 and 90 degrees although it will be appreciated that other angles may also be useful.

While specific embodiments of the invention have been described and illustrated, such embodiments should be considered illustrative of the invention only and not as limiting the invention as construed in accordance with the accompanying claims.

1. An apparatus for supporting a plant having a stem, the apparatus comprising:
a first support member extending between first and second ends, said first support member having an upright portion proximate to said first end, a first ground penetrating member proximate to said second end and a horizontal portion therebetween; and
a second support member having second and third spaced apart ground penetrating members and a connecting portion therebetween, said connecting portion of said second support member being connected to said first support member and remaining below said horizontal portion of said first support member.

2. The apparatus of claim 1 wherein said second support member is secured to said horizontal portion of said first support member by a method selected from the group comprising welding, brazing, adhesives, utilizing fasteners or soldering.

3. The apparatus of claim 1 wherein said first and second support members are co-formed with each other.

4. The apparatus of claim 1 wherein said first second and third ground penetrating members are substantially parallel with each other.

5. The apparatus of claim 4 wherein said first second and third ground penetrating members are substantially parallel with said upright portion.

6. The apparatus of claim 5 wherein said first second and third ground penetrating members are offset from said upright portion by an offset distance.

7. The apparatus of claim 6 wherein said offset distance is between 2.5 and 24 inches.

8. (canceled)
